(19) United States
(12) Patent Application Publication
(10) Pub. No.: US 2025/0086655 A1
(43) Pub. Date: Mar. 13, 2025

(54) Multi-Computer System for Dynamic Fraud Mapping Interface Generation

(71) Applicant: Bank of America Corporation, Charlotte, NC (US)

(72) Inventors: Jack Franklin Price, JR., McKinney, TX (US); Allison M. Glenn, Chicago, IL (US); Susan Hart, Anna, TX (US); Benjamin F. Tweel, Romeoville, IL (US); Anna Burchman, Staten Island, NY (US)

(21) Appl. No.: 18/244,445

(22) Filed: Sep. 11, 2023

(51) Int. Cl. G06Q 30/018; G06F 9/451

(52) U.S. Cl. CPC G06Q 30/0185; G06F 9/451

(57) ABSTRACT

Arrangements for dynamic generation of interactive fraud mapping interfaces are provided. In some examples, fraud reporting data may be received by a computing platform. The fraud reporting data may include incidents of potentially fraudulent activity reported by a plurality of users. If at least a threshold volume of fraud reporting data is received, the fraud reporting data may be analyzed using a machine learning engine. For instance, the fraud reporting data may be input to the machine learning engine to output one or more compromised or potentially compromised payment terminals, vendor or retail locations, or the like. In some examples, the computing platform may generate an interactive fraud mapping interface that includes an interactive icon associated with each compromised location of the one or more compromised locations. The interactive fraud mapping interface may be transmitted or sent to a user computing device for display.

### BACKGROUND

Aspects of the disclosure relate to electrical computers, systems, and devices providing dynamic mapping interface generation.

Potential unauthorized activity initiated by unauthorized actors is a daily occurrence. Currently, users may swipe a debit card, credit card, or the like at any payment terminal and may be at risk for unauthorized access to card or account numbers via skimmers or other methods of capturing payment device data without user permission. Accordingly, it would be advantageous to provide an interactive unauthorized activity mapping interface that identifies, based on machine learning analysis, potentially compromised terminals or locations to enable users to identify potential issues and mitigate impact of those issues.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated dynamically generating graphical displays of potentially unauthorized activity.

In some examples, fraud reporting data may be received by a computing platform. The fraud reporting data may include incidents of potentially fraudulent activity reported by a plurality of users. In some arrangements, a determination may be made as to whether at least a threshold number or volume of fraud reporting data has been received. If not, the system may continue to receive fraud reporting data. If so, the fraud reporting data may be analyzed using a machine learning engine. For instance, the fraud reporting data may be input to the machine learning engine. When executed, the machine learning engine may output one or more compromised or potentially compromised payment terminals, vendor or retail locations, or the like.

In some examples, the computing platform may generate an interactive fraud mapping interface that includes an interactive icon associated with each compromised location of the one or more compromised locations. The interactive fraud mapping interface may be transmitted or sent to a user computing device for display.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing interactive fraud mapping interface generation in accordance with one or more aspects described herein;

FIGS. 2A-2G depict an illustrative event sequence for implementing interactive fraud mapping interface generation in accordance with one or more aspects described herein;

FIG. 3 depicts an illustrative method for implementing interactive fraud mapping interface generation in accordance with one or more aspects described herein;

FIGS. 4A-4C illustrate example interactive fraud mapping interfaces and additional interfaces that may be generated in accordance with one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, providing accurate visual representations of compromised payment terminals can be an efficient way to inform users of potential risk. Accordingly, aspects described herein analyze fraud reporting data to generate an interactive fraud mapping interface.

In some examples, the interactive fraud mapping interface may include a map of a geographical area and a plurality of interactive icons or interface elements, each icon corresponding to a compromised or potentially compromised physical location of a payment terminal or vendor location. Accordingly, a user may review the interactive fraud mapping interface and recognize locations at which the user recently executed a transaction (e.g., locations at which user information may have been obtained by unauthorized users based on the compromised payment device).

In some arrangements, a user may select an interactive icon to prompt generation and display of one or more additional interfaces, such as a fraud details interface, that may provide additional details about incidents of potential fraud at the selected location. In some examples, a user may be able to report potentially fraudulent activity via the interactive fraud mapping interface and/or the one or more additional interfaces.

These and various other arrangements will be discussed more fully below.

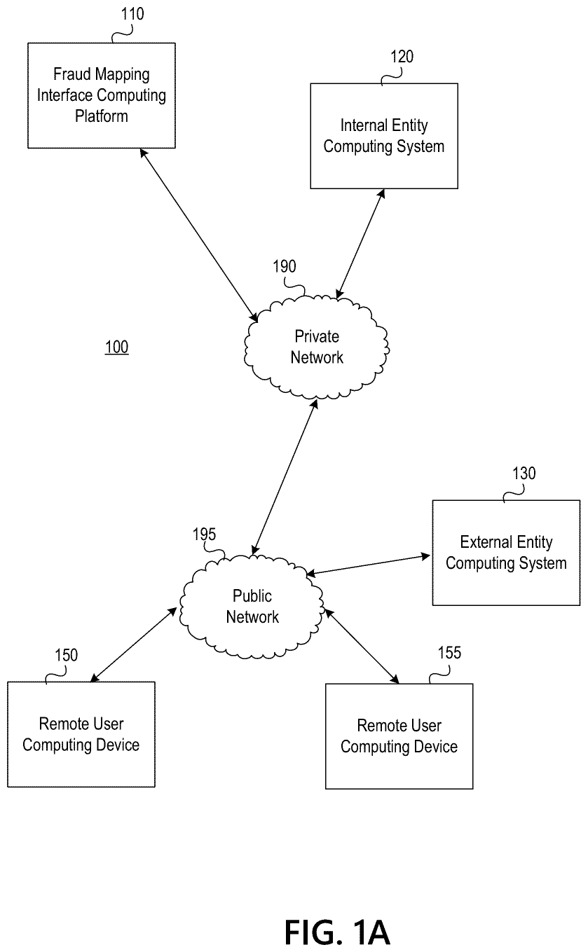

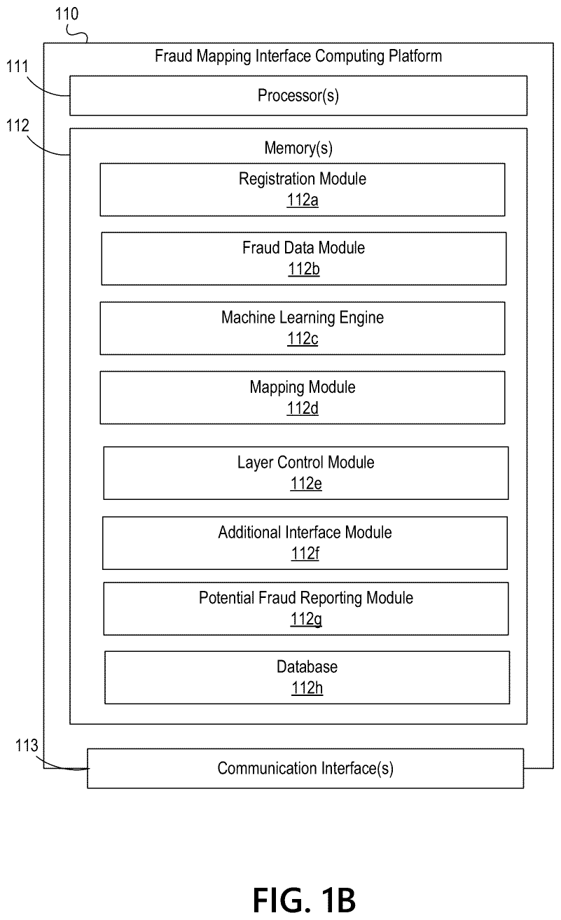

FIGS. 1A-1B depict an illustrative computing environment for implementing dynamic fraud incident mapping functions in accordance with one or more aspects described herein. Referring to FIG. 1A, computing environment 100 may include one or more computing devices and/or other computing systems. For example, computing environment 100 may include fraud mapping interface computing platform 110, internal entity computing system 120, external entity computing system 130, remote user computing device 150 and remote user computing device 155. Although one internal entity computing system 120, one external entity computing system 130 and two remote user computing devices 150, 155 are shown, more or fewer devices or systems may be used without departing from the invention. Further, while fraud mapping interface computing platform 110 is shown as a separate device from internal entity computing system 120, in some examples, fraud mapping interface computing platform 110 and internal entity computing system 120 may be part of a same device.

Fraud mapping interface computing platform 110 may be or include one or more computing devices (e.g., servers, server blades, or the like) and/or one or more computing components (e.g., memory, processor, and the like) and may be configured to provide dynamic, efficient interactive fraud mapping interface generation and modification based on analyzed fraud reporting data. For instance, fraud mapping interface computing platform 110 may receive fraud reporting data including a plurality of potentially fraudulent incidents (e.g., fraudulent transactions, or the like) reported by a plurality of users to an enterprise organization, such as a financial institution. For instance, users may report stolen credit or debit cards, unauthorized use of credit or debit cards, unauthorized use of account numbers, or the like. In some examples, this data may be captured by unauthorized users via a payment or transaction device at a vendor (e.g., via a skimmer attached to a payment terminal, via unauthorized actors stealing card or account numbers, or the like). Accordingly, upon reaching a threshold amount of data (e.g., a sufficient number of reports of fraudulent activity to analyze the fraud reporting data), a machine learning model may be used to analyze the fraud reporting data to identify one or more compromised locations within the fraud reporting data. For instance, the machine learning model may be executed to identify patterns or sequences in the data that may correspond to a particular payment terminal, vendor location, or the like, at which a compromise occurred.

Upon identifying one or more compromised devices, the fraud mapping interface computing platform 110 may generate an interactive fraud mapping interface. The interactive fraud mapping interface may include an interactive icon or interface element identifying a physical location of a compromised device or location on a map of a geographical area. In some examples, the map may include a center point corresponding to a particular user's home, work location or other customized central location. The interactive fraud mapping interface may then display a map of a geographical area including locations within a predetermined radius of the central location (e.g., within one mile, three miles, five miles, or the like). Accordingly, all compromised locations or devices identified may be displayed on the fraud mapping interface if within the geographical area (e.g., predetermined radius of the home location). The generated interface may be transmitted to a user computing device for display. This may enable users to quickly visualize locations or devices at locations that have been compromised and evaluate risk to the user.

In some examples, fraud mapping interface computing platform 110 may receive user input of a user interaction with an interactive icon or interface element. For instance, the user may click, double click, hover over, or the like, the interactive icon or interface element which may prompt generation of an additional user interface. In some examples, the additional user interface may include additional details of the fraud (e.g., number of incidents, particular device within a location at which compromise occurred, types of incidents, remediation status, and the like). Accordingly, the user may obtain additional information related to the incidents at a particular location or device to further enable their risk assessment.

In some examples, the additional user interface may include a selectable option to report a fraud incident. For instance, a user may view the interactive fraud mapping interface and recognize a location as a location at which they recently made a purchase. Accordingly, the user may select an option to report a fraud incident which may then enable the user to freeze a card, request a new card, change a password or PIN, or the like.

Internal entity computing system 120 may be or include one or more computing devices (e.g., servers, server blades, or the like) and/or one or more computing components (e.g., memory, processor, and the like) and may be configured to host or execute one or more applications associated with the enterprise organization, such as customer facing application (e.g., a web-based or mobile application), internal applications associated with user accounts, customer data management, transaction processing, fraud reporting, or the like. In some examples, internal entity computing system 120 may store customer fraud incident reporting data associated with a plurality of users or customers of the enterprise organization. The fraud reporting data may include user identifying information, type of payment device associated with the fraud incident (e.g., credit card, debit card, or the like), time, date, vendor or party to the transaction, location data, and the like. Internal entity computing system 120 may host one or more systems or applications configured to receive reports of fraudulent or potentially fraudulent activity, initiate investigations, execute instructions to modify account settings (e.g., change password or personal identification number, or the like), disable or otherwise freeze a payment device, replace a payment device, or the like.

External entity computing system 130 may be or include one or more computing devices (e.g., servers, server blades, or the like) and/or one or more computing components (e.g., memory, processor, and the like) and may be associated with an entity external to the enterprise organization, such as a vendor at which customers of the enterprise organization have executed transactions and/or reported potentially fraudulent activity. In some examples, interactive fraud mapping interfaces may be generated for vendor review to identify or visualize reports of potential fraud at various locations of the vendor. Further, one or more notifications may be transmitted to the vendor via external entity computing system 130 to notify the vendor of the compromised status, request remediation, or the like. In some examples, external entity computing system 130 may report a remediation status to the fraud mapping interface computing platform 110 to indicate a compromised has been addressed in order to update any generated fraud mapping interfaces (e.g., remote an indication of compromise associated with that vendor location).

Remote user computing device 150 and/or remote user computing device 155 may be or include computing devices such as desktop computers, laptop computers, tablets, smartphones, wearable devices, and the like, that may be associated with a user or customer (e.g., a customer of the enterprise organization). Remote user computing device 150 may be a device associated with a same user as associated with remote user computing device 155, or a different user. Remote user computing device 150, 155 may, in some examples, conduct or execute transactions (e.g., online transactions using different payment methods or devices, transactions using a mobile payment application, or the like). In some examples, remote user computing device 150 and/or remote user computing device 155 may be configured to display the dynamically generated interactive fraud mapping interface and/or any additional interfaces, control display of data via the interactive fraud mapping interface by selecting or de-selecting data layers, report potentially fraudulent transactions via the interactive fraud mapping interface, and the like.

As mentioned above, computing environment 100 also may include one or more networks, which may interconnect one or more of fraud mapping interface computing platform 110, internal entity computing system 120, external entity computing system 130, remote user computing device 150 and/or remote user computing device 155. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, fraud mapping interface computing platform 110, and/or internal entity computing system 120 may be associated with an enterprise organization (e.g., a financial institution), and private network 190 may be associated with and/or operated by the organization, and may include one or more networks (e.g., LANs, WANs, virtual private networks (VPNs), or the like) that interconnect fraud mapping interface computing platform 110 and/or internal entity computing system 120 and one or more other computing devices and/or computer systems that are used by, operated by, and/or otherwise associated with the organization. Public network 195 may connect private network 190 and/or one or more computing devices connected thereto (e.g., fraud mapping interface computing platform 110, internal entity computing system 120.) with one or more networks and/or computing devices that are not associated with the organization. For example, external entity computing system 130, remote user computing device 150 and/or remote user computing device 155 might not be associated with an organization that operates private network 190 (e.g., because external entity computing system 130, remote user computing device 150 and/or remote user computing device 155 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 130, remote user computing device 150 and/or remote user computing device 155 to private network 190 and/or one or more computing devices connected thereto (e.g., fraud mapping interface computing platform 110, internal entity computing system 120).

Referring to FIG. 1B, fraud mapping interface computing platform 110 may include one or more processors 111, memory 112, and communication interface 113. A data bus may interconnect processor(s) 111, memory 112, and communication interface 113. Communication interface 113 may be a network interface configured to support communication between fraud mapping interface computing platform 110 and one or more networks (e.g., network 190, network 195, or the like). Memory 112 may include one or more program modules having instructions that when executed by processor(s) 111 cause fraud mapping interface computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of fraud mapping interface computing platform 110 and/or by different computing devices that may form and/or otherwise make up fraud mapping interface computing platform 110.

For example, memory 112 may have, store and/or include registration module 112a. Registration module 112a may store instructions and/or data that may cause or enable the fraud mapping interface computing platform 110 to receive, from one or more users or customers, a request to register with the fraud mapping interface computing platform 110. For instance, users or customers of the enterprise organization may opt in to have fraud incident reporting data presented via an interactive fraud mapping interface generated by fraud mapping interface computing platform 110. Accordingly, users may provide permissions to the fraud mapping interface computing platform 110 to receive and analyze access location or address information of the user, receive user customization options (e.g., additional areas to view outside of home location, distance from home location to display compromised devices or locations), or the like.

Fraud mapping interface computing platform 110 may further have, store and/or include fraud data module 112b. Fraud data module 112b may store instructions and/or data that may cause or enable the fraud mapping interface computing platform 110 to receive incident data associated with a plurality of potentially fraudulent incidents or activities as reported by a plurality of users. In some examples, the users may be customers of the enterprise organization associated with the fraud mapping interface computing platform 110. The fraud data may include identification of the user, type of payment device associated with the fraudulent activity, vendors or other parties to the transaction identified as potentially fraudulent, amount of transaction, type of transaction, account associated with the potentially fraudulent activity, location of the user and/or vendor, and the like.

Fraud mapping interface computing platform 110 may further have, store and/or include a machine learning engine 112c. Machine learning engine 112c may store instructions and/or data that may cause or enable the fraud mapping interface computing platform 110 to train, execute, validate and/or update one or more machine learning models that may be used to evaluate fraud reporting data to identify, predict or otherwise output compromised or potentially compromised devices or locations. For instance, the machine learning model may receive, as inputs, reported incidents of potentially fraudulent activity and may identify, as outputs, one or more compromised or potentially compromised payment terminals, vendor or retail locations, or the like.

In some examples, the machine learning model may be trained using historical fraud data. For instance, the machine learning model may be trained using fraud reporting data associated with previously reported incidents of fraud, outcomes of investigations associated with the incidents, locations associated with incidents or geographic areas near incidents, and the like to identify correlations between the reported potentially fraudulent activity and one or more compromised or potentially compromised payment terminals or locations. Accordingly, the machine learning model may learn to recognize patterns or sequences within fraud reporting data that may be used to output compromised or potentially compromised payment terminals, vendor or retail locations, or the like.

In some examples, a dynamic feedback loop may be used to continuously update or validate the machine learning model. For instance, as additional incidents of fraud are reported, investigated, and the like, the machine learning model may be updated and/or validated to continuously improve accuracy of identified compromised locations or devices.

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data (e.g., labeled data identify confirmed incidents of fraud, types of payment devices compromised, and the like) and/or unlabeled data.

Fraud mapping interface computing platform 110 may further have, store and/or include mapping module 112d. Mapping module 112d may store instructions and/or data that may cause or enable the fraud mapping interface computing platform 110 generate an interactive fraud mapping interface displaying or identifying compromised locations or payment terminals on a map of a geographic area. For instance, a map having a center point at a user specified location (e.g., home, work, other specified location) may be generated and may include a display of a map of a geographic location extended a predetermined distance from the specified location (e.g., a one mile radius, a three mile radius, a five mile radius, or the like). In some examples, a user may specify more than one location (e.g., a home location and a work location) to display. Accordingly, fraud mapping interface computing platform 110 may generate the fraud mapping interface for the geographic region and may display one or more interactive icons or interface elements identifying physical locations of a compromised payment terminal, vendor or retail location, or the like. In some examples, a size of the interactive icon or interface element may indicate a volume, number or range of fraudulent or potentially fraudulent incidents associated with the location (e.g., a larger sized icon may indicate more incidents than a smaller sized icon). Additionally or alternatively, color may be used to indicate a recency of incidents. For instance, a red icon may be used to show very recent incidents of fraud (e.g., within one month), while yellow may show less recent (e.g., between two months ago and one month ago), while green may indicate the least recent (e.g., greater than two months ago). Accordingly, the user may quickly identify, from the interface, how many incidents occurred at a location, how recently, and may then evaluate risk of using a payment device at the location. In some examples, the compromised locations may be displayed on a display similar to a heat map to indicate proximity to a user. The size and color arrangements described are merely some examples. Other arrangements may be used without departing from the invention.

In some examples, mapping module 112d may be configured to receive, from one or more vendors or other external entities, reports of remediation of an identified compromise. Accordingly, mapping module 112d may generate one or more indications of reported remediation of a compromise (e.g., a flag or other indicator associated with the icon, or the like).

Fraud mapping interface computing platform 110 may further have, store and/or include layer control module 112e. Layer control module 112e may store instructions and/or data that may cause or enable the fraud mapping interface computing platform 110 to generate one or more data layers for display and selectively display the data layers based on user input. For instance, users may select to display data associated with certain types of payment devices (e.g., credit card vs. debit card), incidents within a user defined time period, locations having greater than a threshold number of incidents, confirmed fraud vs. reported fraud, or the like. Accordingly, the layer control module 112e may be used in conjunction with the mapping module 112d and machine learning engine 112c to generate different layers of data for display.

Fraud mapping interface computing platform 110 may further have, store and/or include additional interface module 112f. Additional interface module 112f may store instructions and/or data that may cause or enable the fraud mapping interface computing platform 110 to dynamically generate one or more additional user interfaces based on, for instance, user interaction with or selection of an icon or interactive element indicating a compromised or potentially compromised payment terminal, vendor or retail location, or the like. The one or more additional interfaces may include additional fraud incident details, a selectable option to report potential fraud, selectable options to display different data layers, reported remediation from the external entity, or the like.

Fraud mapping interface computing platform 110 may further have, store and/or include potential fraud reporting module 112g. Potential fraud reporting module 112g may store instructions and/or data that may cause or enable the fraud mapping interface computing platform 110 to establish a connection with an enterprise organization fraud reporting platform and transmit a report of potential fraud to the enterprise organization fraud reporting platform. In some examples, the connection may include causing display of a user interface associated with the enterprise organization fraud reporting platform to the user. Further, in some examples, potential fraud reporting module 112g may generate and transmit notifications to one or more other groups within the enterprise organization indicating potential fraud and/or external to the enterprise organization (e.g., one or more vendors, retail locations, or the like, at which compromise is indicated).

Fraud mapping interface computing platform 110 may further have, store and/or include a database 112h. Database 112h may store data associated with user registration, fraud reporting data, generated data layers, potential fraud reports, compromised or potentially compromised locations, vendor reported remediation status, and/or other data that enables performance of the aspects described herein by the fraud mapping interface computing platform 110.

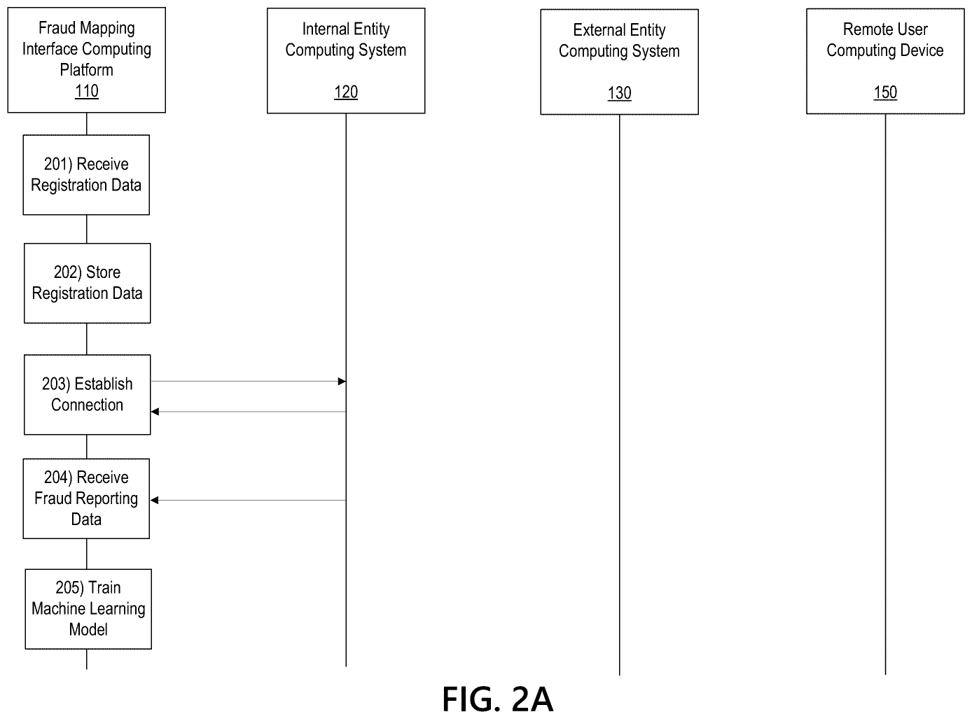

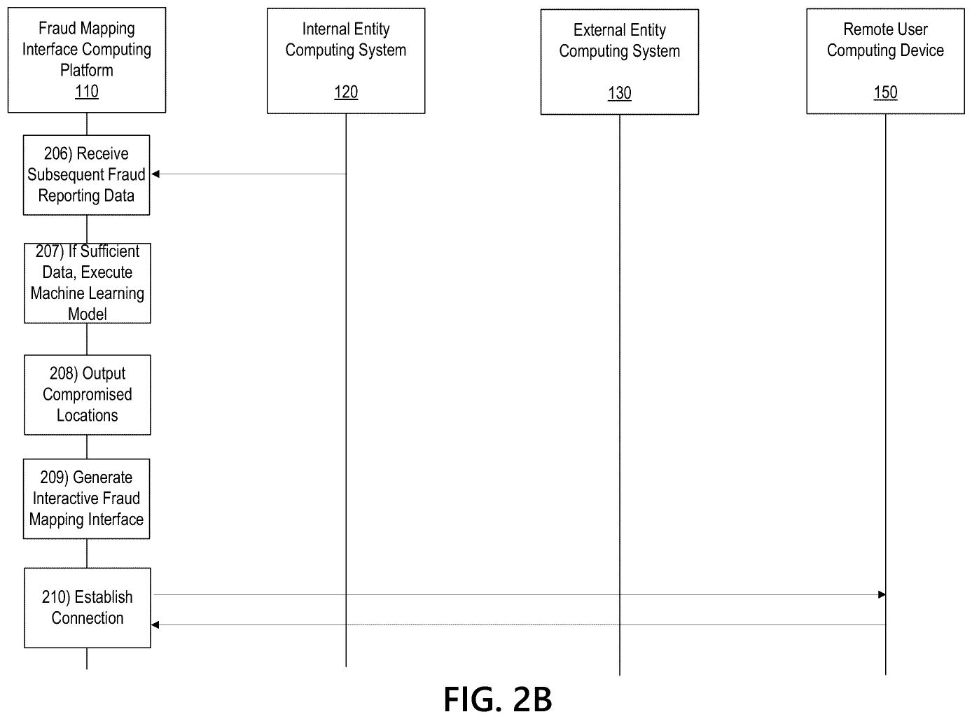

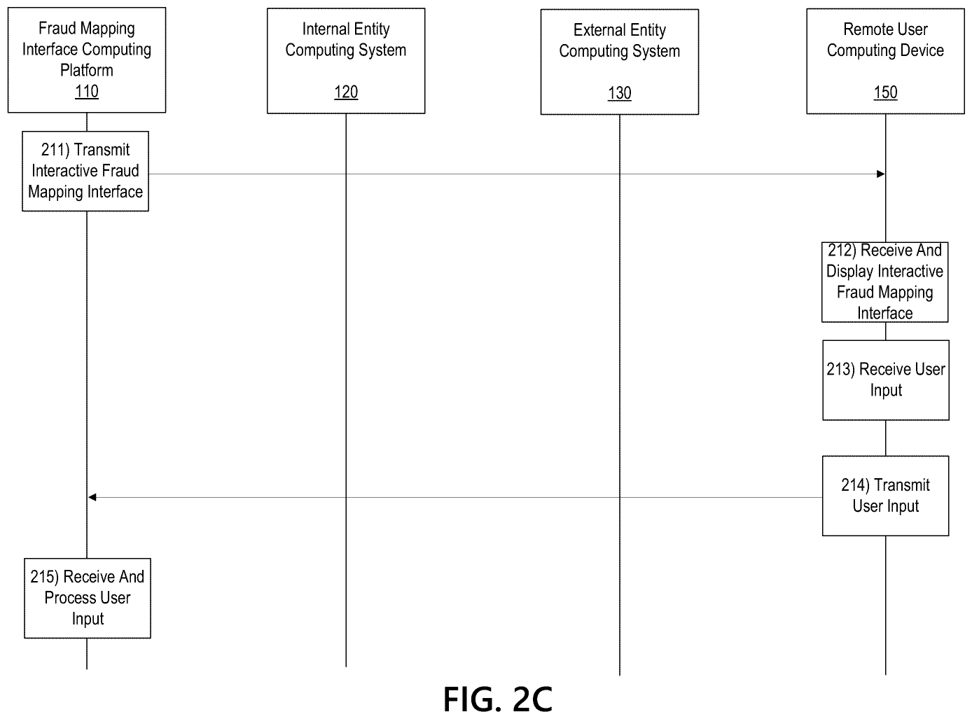

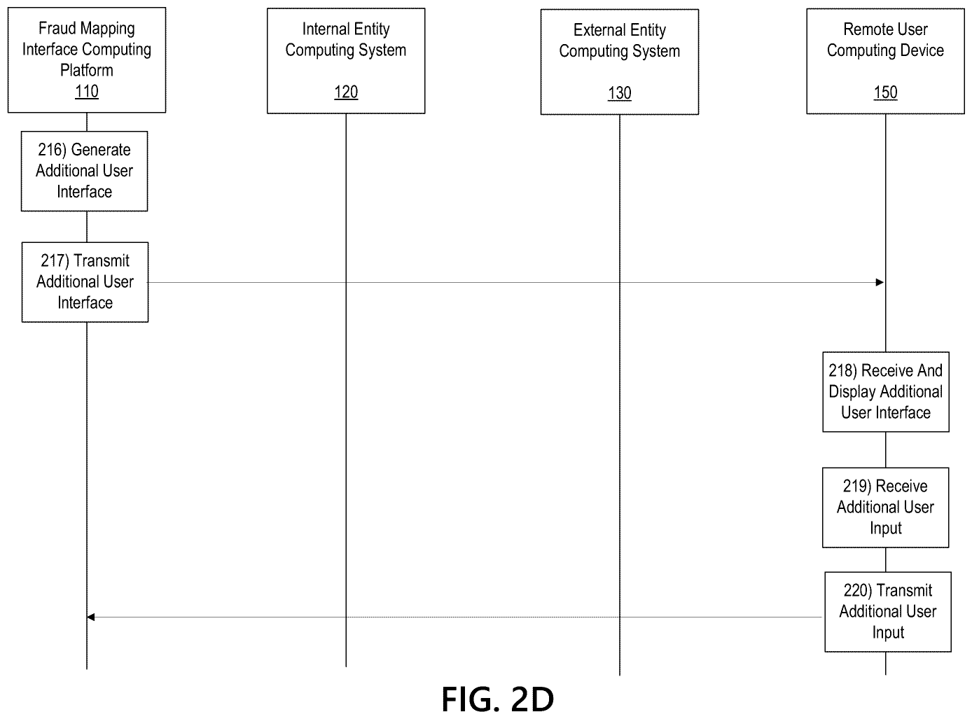

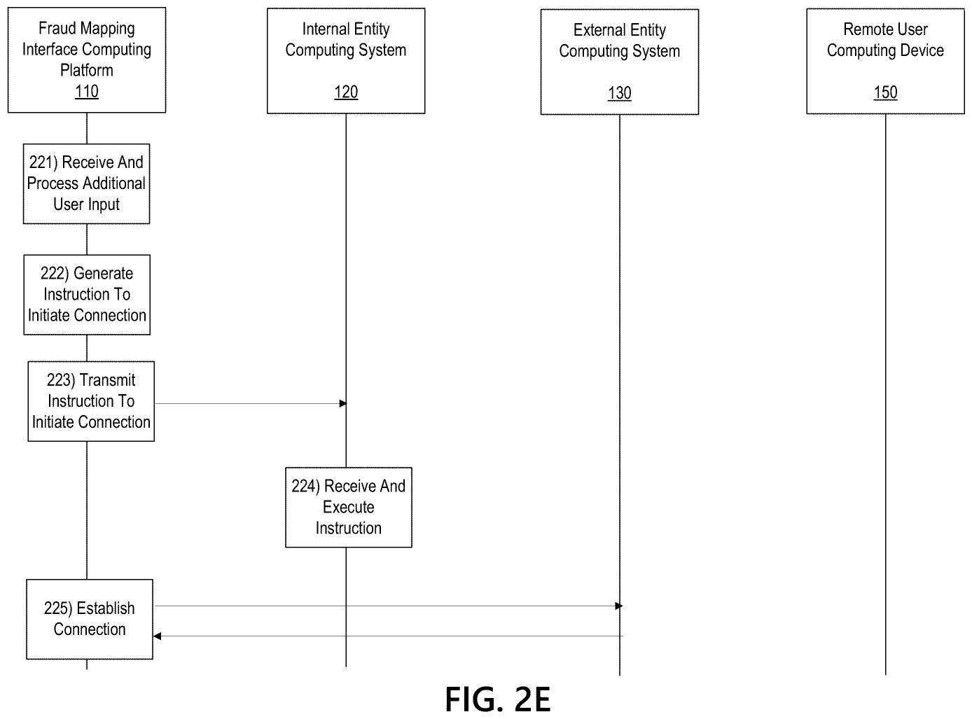

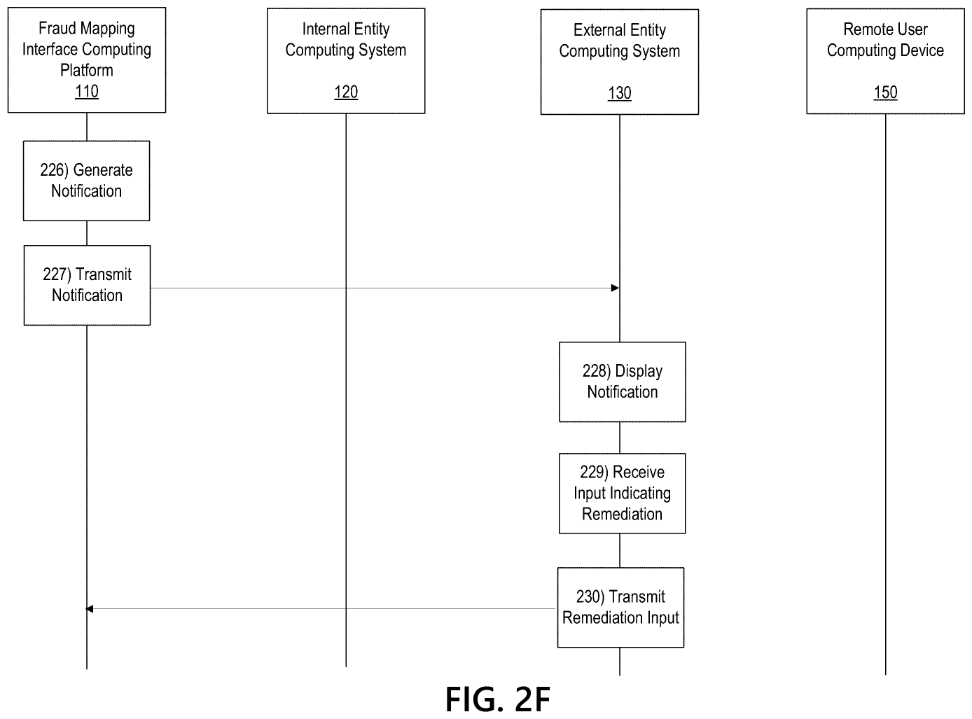

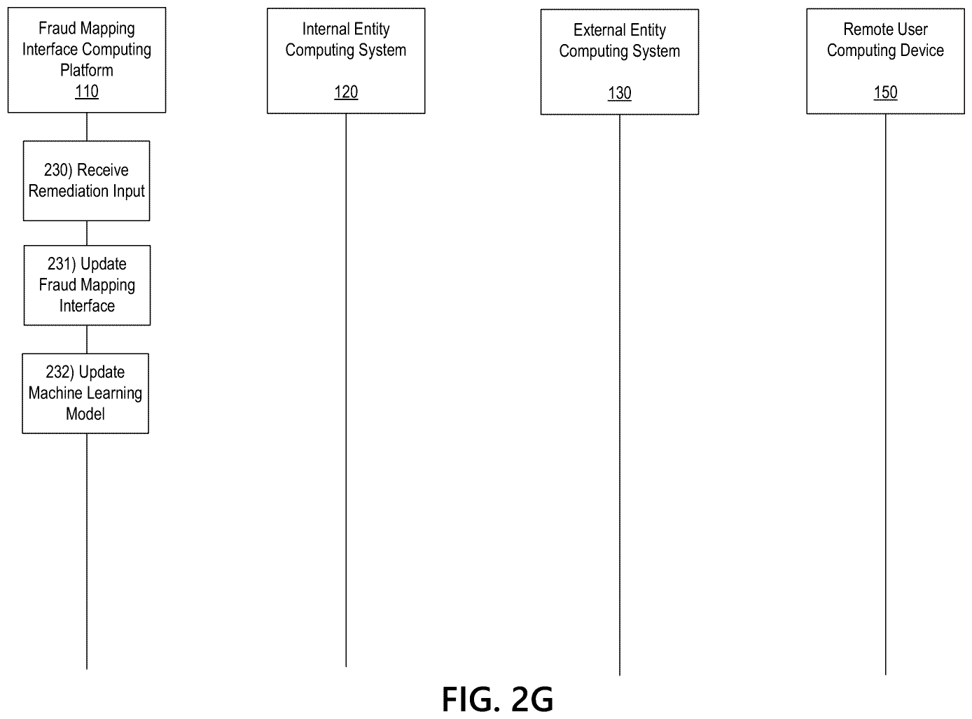

FIGS. 2A-2G depict one example illustrative event sequence for implementing fraud mapping interface generation in accordance with one or more aspects described herein. The events shown in the illustrative event sequence are merely one example sequence and additional events may be added, or events may be omitted, without departing from the invention. Further, one or more processes discussed with respect to FIGS. 2A-2G may be performed in real-time or near real-time.

With reference to FIG. 2A, at step 201, fraud mapping interface computing platform 110 may receive registration data. For instance, fraud mapping interface computing platform 110 may receive registration data from a plurality of users or customers of the enterprise organization implementing the fraud mapping interface computing platform 110. The registration data may include user identifying data, user permission data, user customization options, locations for central point in mapping interface, distance from center point to display, and the like.

At step 202, the fraud mapping interface computing platform 110 may store the received registration data. For instance, for each user identified in the registration data, fraud mapping interface computing platform 110 may modify a database to include a data entry associated with the user, registration data for the user, and the like.

At step 203, fraud mapping interface computing platform 110 may establish a connection with the internal entity computing system 120. For instance, a first wireless connection may be established between the fraud mapping interface computing platform 110 and the internal entity computing system 120. Upon establishing the first wireless connection, a communication session may be initiated between the fraud mapping interface computing platform 110 and the internal entity computing system 120.

At step 204, fraud mapping interface computing platform 110 may receive historical fraud reporting data from the internal entity computing system 120. For instance, historical fraud reporting data including reports of potentially fraudulent incidents from a plurality of users, vendors or payment terminals associated with incidents (e.g., based on reported unauthorized activity or attempted activity), outcome of investigation into the reports of potentially fraudulent incidents, confirmation of fraud/no fraud for each incident, or the like, may be received from the internal entity computing system 120.

At step 205, fraud mapping interface computing platform 110 may train a machine learning model using the historical fraud reporting data. For instance, fraud mapping interface computing platform 110 may, using or based on the historical fraud reporting data, train the machine learning model to identify patterns or sequences in fraud data and output one or more compromised or likely compromised payment terminals, locations, or the like. For instance, historical incidents of reported fraud that were identified as fraud and not fraud may be used to train the machine learning model to identify correlations between reported potentially fraudulent incidents and one or more payment terminals or locations. Accordingly, the machine learning model may use, as inputs, current, recent, real-time, or the like, fraud data and the inputs may be analyzed using the machine learning model to output one or more compromised or potentially compromised payment terminals, vendor or retail locations, or the like.

With reference to FIG. 2B, at step 206, fraud mapping interface computing platform 110 may receive subsequent fraud data from internal entity computing system 120. For instance, fraud mapping interface computing platform 110 may receive recently reported incidents of potentially fraudulent activity, locations or terminals of unauthorized activity (if available), types of payment devices used in the unauthorized activity, and the like. In some examples, the fraud data may be analyzed to determine whether at least a threshold amount of fraud data is available (e.g., at least a threshold number of reports, at least a threshold number of reports in a location (e.g., zip code, geographic location, city, or the like), and the like. If not, the fraud mapping interface computing platform 110 may continue to receive fraud data. If so, the process may move to step 207.

At step 207, fraud mapping interface computing platform 110 may execute the machine learning model. For instance, the fraud data received at step 206 may be input into the machine learning model and the model may be executed. The machine learning model may then output, based on the analysis, one or more compromised or potentially compromised payment terminals, vendor or retail locations, or the like, at step 208.

At step 209, fraud mapping interface computing platform 110 may generate an interactive fraud mapping interface. For instance, fraud mapping interface computing platform 110 may dynamically generate an interactive interface including a map of a geographical location. In some examples, the center point of the map may be a user selected or identified location (e.g., a home location, a work location, or the like). The interactive fraud mapping interface may include one or more interactive icons or interface elements indicating a physical location on the map that includes a compromised or potentially compromised payment terminal, vendor or retail location, or the like. In some examples, the interactive icon may include a size indicating a volume of reported incidents at a corresponding location. Additionally or alternatively, the interactive icon may include a color indicating a recency of reported incidents.

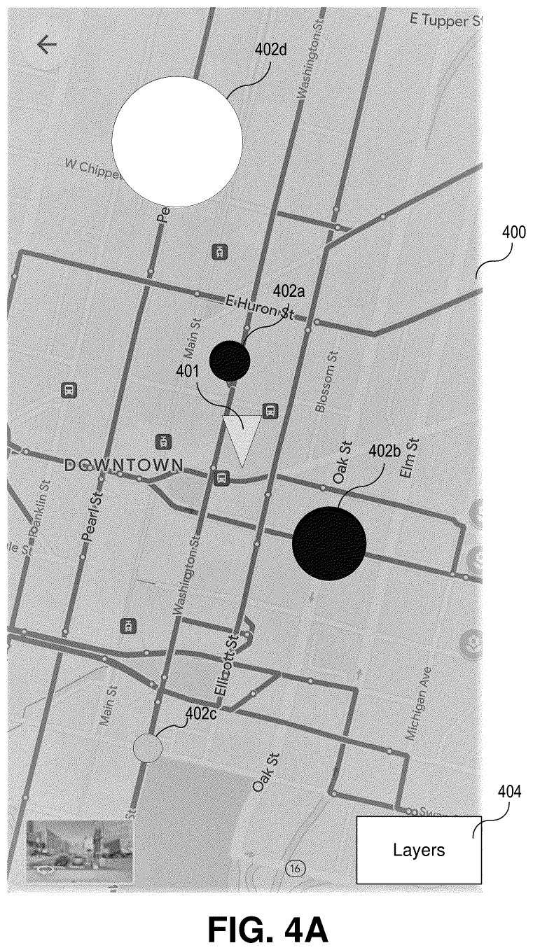

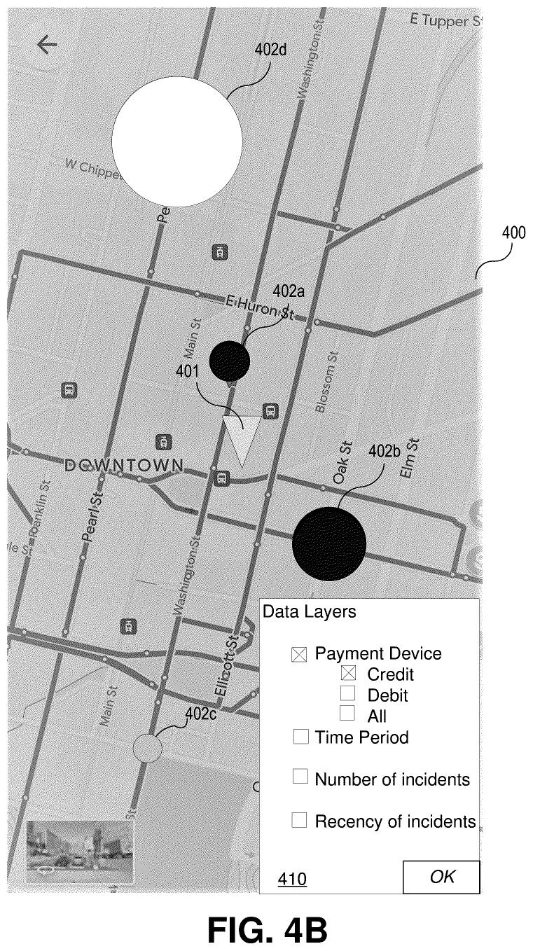

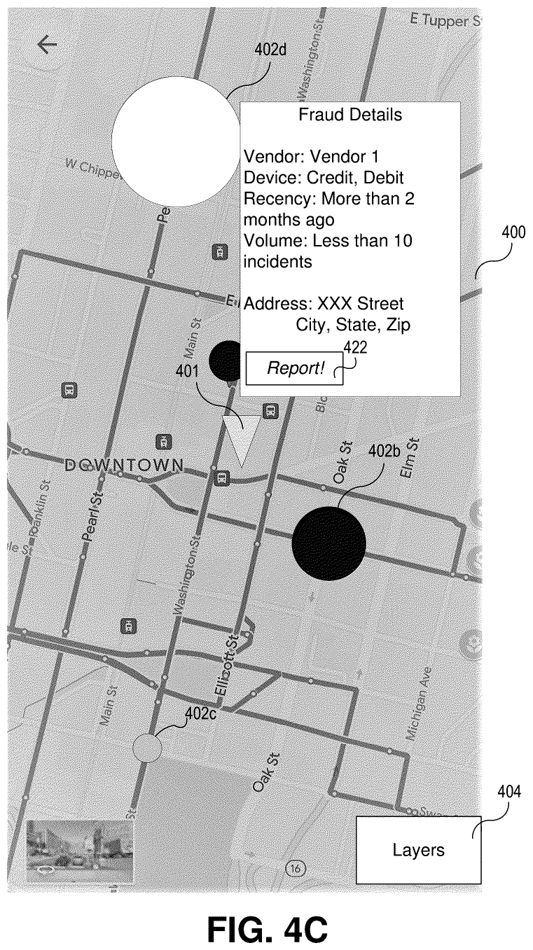

For example, FIG. 4A illustrates one example interactive fraud mapping interface 400. The interface 400 includes a map of a geographic location with a marker 401 identifying a substantially center point location of the map. The marker 401 may be associated with a user selected or identified center point, such as a home location, work location, or the like. Further, the interface 400 includes a plurality of interactive icons or selectable interface elements 402a, 402b, 402c, 402d identifying physical locations of one or more compromised or potentially compromised payment terminals, vendor or retail locations, or the like. While four compromised or potentially compromised locations are shown in the interactive fraud mapping interface 400, more of fewer locations may be shown without departing from the invention. Further, as a user expands or contracts the geographical area shown in the interactive fraud mapping interface (e.g., by zooming in or out) or modifies a radius or distance from the center point location to display, more of fewer compromised or potentially compromised locations may be displayed (e.g., based on the modified geographical location).

Further, as show in the interface 400, the interactive icons 402a-402d may include varying sizes that may indicate a volume or number of incidents at the corresponding location. For instance, a larger interactive icon may indicate more incidents than a smaller interactive icon. Additionally or alternatively, color or shading of the interactive icon 402a-402d may be used to indicate recency of reported incidents at a corresponding location. For instance, darker shading (such as shown on icons 402a and 402b) may indicate more recent incidents than the lighter shading shown on icon 402c which may be more recent than 402a and 402b but less recent than the lightest shading shown on interactive icon 402d. The shading or color arrangements shown and described are merely some examples. Other shading or color schemes may be used without departing from the invention.

Interactive fraud mapping interface 400 may further include a selectable option to modify the data layers displayed via the interactive fraud mapping interface 400. For instance, selection of “layers” option 404 may cause generation of an additional user interface 410 shown in FIG. 4B that includes selectable options for display of different data layers within the interactive fraud mapping interface 400. For instance, a user may select to display data layers associated with different types of payment devices in the reported incidents, a time period of reported incidents, a volume of reported incidents, a recency of reported incidents, and the like. Selection or deselection of one or more data layers may cause modification of the interactive fraud mapping interface 400 to display the data in the selected data layer. The selectable data layers shown are merely some example data layers and additional data layers may be provided for selection without departing from the invention.

With further reference to FIG. 2B, at step 210, fraud mapping interface computing platform 110 may establish a connection with the remote user computing device 150. For instance, a second wireless connection may be established between the fraud mapping interface computing platform 110 and the remote user computing device 150. Upon establishing the second wireless connection, a communication session may be initiated between the fraud mapping interface computing platform 110 and the remote user computing device 150.

With reference to FIG. 2C, at step 211, fraud mapping interface computing platform 110 may transmit or send the interactive fraud mapping interface to the remote user computing device 150. For instance, the interactive fraud mapping interface may be transmitted or sent during the communication session initiated upon establishing the second wireless connection. In some examples, transmitting or sending the interactive fraud mapping interface may cause the remote user computing device 150 to display the interactive fraud mapping interface on a display of the remote user computing device 150.

At step 212, remote user computing device 150 may receive and display the interactive fraud mapping interface transmitted at step 211.

At step 213, remote user computing device 150 may receive user input selecting or otherwise interacting with one of the interactive icons or interactive interface elements in the interactive fraud mapping interface. In some examples, selection of or interaction with the interactive icon or interactive interface element may include clicking or double clicking the icon or interactive interface element, hovering over the icon or interactive interface element, or the like.

At step 214, the remote user computing device 150 may transmit or send the user input to the fraud mapping interface computing platform 110. For instance, an indication of the user selection of or interaction with the interactive icon or interactive interface element, as well as an indication of which icon or interface element was selected, may be transmitted or sent to the fraud mapping interface computing platform 110.

At step 215, the fraud mapping interface computing platform 110 may receive and process the user input. For instance, fraud mapping interface computing platform 110 may identify the compromised or potentially compromised payment terminal or vendor location corresponding to the selected icon or interactive interface element and may retrieve fraud incident details associated with the location.

With reference to FIG. 2D, at step 216, fraud mapping interface computing platform 110 may generate an additional user interface. In some examples, the additional user interface may include a fraud details interface providing additional details of the fraud incidents associated selected compromised or potentially compromised payment terminal or location. For instance, the fraud details interface may include a name and address of the vendor or entity associated with the location, identification of one or more particular payment terminals (e.g., gas pump #3), a number or range of incidents at the location (e.g., “75 to 100 incidents were reported here”), recency data (e.g., “most incidents occurred within the last 30 days”), and the like. FIG. 4C illustrates one example additional user interface, such as a fraud details interface 420. The fraud details interface 420 may include additional fraud incident details associated with the selected location, such as a vendor name and address corresponding to the selected location, types of devices associated with the incidents (e.g., credit, debit), a recency of incidents (e.g., “more than 2 months ago”), a volume or number of incidents (e.g., “less than 10 incidents”), and the like.

In some examples, the fraud details interface 420 may include a selectable option 422 to report potentially fraudulent activity at the selected compromised location. For instance, a user may review the interactive fraud mapping interface to identify locations that the user has visited that are compromised or potentially compromised. In some cases, the user might not have visited any of the compromised locations. In other examples, a user may have recently visited one of the locations identified as compromised or potentially compromised. Accordingly, the user may select “report” option 422 to cause initiation of a communication session with a fraud reporting system of the enterprise organization. The user may provide additional details, may select options to freeze a card, request a replacement card, or the like.

The arrangements shown in FIG. 4C are just some example additional interface arrangements. Other arrangements may be used without departing from the invention.

With further reference to FIG. 2D, at step 217, fraud mapping interface computing platform 110 may transmit or send the additional user interface to the remote user computing device 150. In some examples, transmitting or sending the additional user interface may cause the remote user computing device 150 to display the additional user interface on the display of the remote user computing device 150.

At step 218, the remote user computing device 150 may receive and display the additional user interface. In some examples, displaying the additional user interface may include displaying the additional user interface as a pop-up or otherwise overlaying the interactive fraud mapping interface. In some examples, the additional user interface may be displayed adjacent to or abutting the icon associated with the compromised location.

At step 219, remote user computing device 150 may receive additional user input. For instance, a user may select a selectable option from the additional user interface to report potentially fraudulent activity (e.g., select option 422 of FIG. 4C).

At step 220, remote user computing device 150 may transmit or send the additional user input to the fraud mapping interface computing platform 110. For instance, remote user computing device 150 may transmit or send the user input including a request to initiate a fraud report to the fraud mapping interface computing platform 110.

With reference to FIG. 2E, at step 221, fraud mapping interface computing platform 110 may receive and process the additional user input. For instance, fraud mapping interface computing platform 110 may identify the compromised or potentially compromised location, user identifying information, and any additional information associated with the potentially fraudulent activity.

At step 222, fraud mapping interface computing platform 110 may generate an instruction to initiate a connection. In some examples, the instruction may include an instruction to initiate a connection between an enterprise organization device or system associated with fraud reporting to the remote user computing device 150. For instance, the instruction may include an instruction to initiate a communication session between internal entity computing system 120 and remote user computing device 150. In some examples, the instruction may include compromised location details, user details related to the potentially fraudulent activity, and any additional information retrieved or identified by the fraud mapping interface computing platform 110 in receiving and processing the user input.

At step 223, fraud mapping interface computing platform 110 may transmit or send the generated instruction to the internal entity computing system 120.

At step 224, internal entity computing system 120 may receive and execute the generated instruction. In some examples, receiving and executing the instruction may cause the internal entity computing system 120 to initiate a communication session with remote user computing device 150. The communication session may include transmitting and displaying user interfaces on the remote user computing device 150 to enable the user to report the potential fraud. In some examples, the user interfaces may be pre-populated with fraud activity and/or compromised location data included in the instruction to initiate the communication session.

Although aspects described herein have been described in the context of providing visual indications of compromised or potentially compromised locations for users or customers. in some examples, the fraud data may be used to provide notifications of compromise or potential compromise for one or more vendors. For instance, at step 225, fraud mapping interface computing platform 110 may establish a connection with external entity computing system 130. For instance, a third wireless connection may be established between the fraud mapping interface computing platform 110 and the external entity computing system 130. Upon establishing the third wireless connection, a communication session may be initiated between the fraud mapping interface computing platform 110 and the external entity computing system 130.

With reference to FIG. 2F, at step 226, fraud mapping interface computing platform 110 may generate one or more notifications of compromised or potentially compromised payment terminals. For instance, a notification identifying an associated vendor or location, particular terminal, type of devices impacted, and the like, may be generated.

At step 227, fraud mapping interface computing platform 110 may transmit or send the generated notification to the impacted vendor via external entity computing system 130 that may be associated with the impacted vendor. In some examples, transmitting or sending the notification may cause the external entity computing system 130 to display the notification on a display of the external entity computing system 130.

At step 228, external entity computing system 130 may display the notification. In some examples, the notification may include one or more options to report remediation of the issue. For instance, if the notification indicates that a skimmer may be connected to a particular payment terminal, the vendor may investigate and, if a skimmer is detected, remove the skimmer and report the remediation via the notification or via other communication to the fraud mapping interface computing platform 110.

At step 229, external entity computing system 130 may receive an indication of remediation of the compromised payment terminal. At step 230, the external entity computing system 130 may transmit or send the reported remediation to the fraud mapping interface computing platform 110.

With reference to FIG. 2G, at step 230, fraud mapping interface computing platform 110 may receive the reported remediation input.

At step 231, fraud mapping interface computing platform 110 may update and/or regenerate interactive fraud mapping interface based on the reported remediation. For instance, a flag or other notice may be attached to the compromised location on the fraud mapping interface indicating that the vendor has reported remediation of the compromise.

At step 232, fraud mapping interface computing platform 110 may update and/or validate the machine learning model. For instance, based on the generated compromised or potentially compromised locations, reported remediation, additional reported fraud, and the like, the machine learning model may be updated and/or validated. Accordingly, a dynamic feedback loop may be used to continuously update or validate the machine learning model to improve accuracy of outputs.

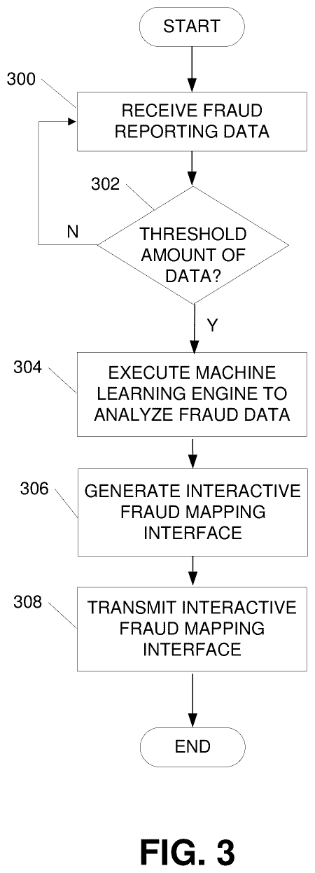

FIG. 3 is a flow chart illustrating one example method of generating interactive fraud mapping interfaces in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform may receive fraud reporting data. The fraud reporting data may include data associated with a plurality of incidents of potentially fraudulent activity reported by a plurality of users. In some examples, the users may be registered users associated with an enterprise organization associated with the computing platform. In some examples, the fraud reporting data may be received in real-time or near real-time.

At step 302, a determination may be made as to whether at least a threshold amount of fraud reporting data has been received. For instance, a determination may be made as to whether at least a threshold number of incidents of potentially fraudulent activity have been reported (e.g., overall, for a particular area, or the like). If not, the process may return to step 300 to receiving additional fraud reporting data.

If at least a threshold amount of fraud reporting data has been received, at step 304, the fraud reporting data may be analyzed using a machine learning model to identify one or more compromised locations (e.g., compromised or potentially compromised payment terminals, vendor or retail locations, or the like). For instance, the machine learning model may receive, as inputs, the fraud reporting data to output the one or more compromised locations.

At step 306, the computing platform may generate an interactive fraud mapping interface. For instance, based on the output one or more compromised locations, the computing platform may generate an interactive fraud mapping interface including an interactive icon identifying each compromised location of the one or more compromised locations on a map of a geographical location. In some examples, a size of the interactive icon may indicate a number or volume of incidents of potentially fraudulent activity at a corresponding compromised location. Additionally or alternatively, a color of the interactive icon may indicate a recency of incidents of potentially fraudulent activity at a corresponding compromised location.

At step 308, the computing platform may transmit or send the generated interactive fraud mapping interface to a user computing device. In some examples, transmitting the interactive fraud mapping interface may cause the user computing device to display the interactive fraud mapping interface on a display of the user computing device.

As discussed herein, aspects are directed to providing accurate visual representations of compromised payment terminals or vendor locations based on machine learning analysis of fraud reporting data. The visual representations may enable a user to quickly recognize locations they may have visited that are compromised and for which the user may want to report potentially fraudulent activity. For instance, a user may recognize a compromised location as a gas station near their home that they visited last week. The user may then monitor the payment device used at that gas station, report potentially fraudulent activity, freeze their card, request a new card, or the like.

As discussed herein, in some examples, at least a threshold amount of fraud reporting data may be received before analyzing the data using the machine learning model. For instance, at least a threshold number of incidents of potential fraud may be received. In some examples, the threshold may be based on location. In some arrangements, at least a threshold number of incidents within a certain location, town, zip code, or the like, may be received before analyzing the data. In some examples, the number of reported incidents may be based on a particular vendor or retail location, payment terminal, or the like. For instance, if at least a threshold number of reports of potentially fraudulent activity are received for a particular vendor or retail location, payment terminal, or the like, the data may then be analyzed to output the one or more compromised locations. As discussed, the reported incidents of potentially fraudulent activity may be received by one or more fraud reporting systems of the enterprise organization, from third-party sources, or the like.

In some examples, different interactive icons may be used to indicate confirmed incidents of fraud and potential or reported incidents of fraud. For instance, if an investigation has been conducted and fraud has been confirmed, that may be shown via a modified interactive icon, in one or more additional interfaces, or the like.

As discussed herein, in some examples, a vendor may report remediation of a compromised payment terminal. Accordingly, that reported remediation may be used to modify the interactive fraud mapping interface to provide an indication that the vendor has reported remediation. In some examples, compromised locations may be monitored by the system to determine whether incidents of fraud have decreased or stopped. For instance, machine learning analysis may be performed on subsequently received fraud reporting data to determine that there are no longer issues with a particular location and, an updated interactive fraud mapping interface may be generated to modify identified compromised locations, size or color of icons associated with a location, or the like. In some examples, if less than a threshold number of incidents are reported for a compromised location, the location may be deemed remediated and might no longer be identified as compromised.

As discussed herein, in some examples, notifications may be generated and transmitted to one or more vendors or retailers associated with a compromised location. Additionally or alternatively, one or more notifications may be generated and transmitted to teams internal to the enterprise organization that address fraud issues to identify the compromised location, initiate investigation if appropriate, or the like.

As discussed, in some examples, the interactive fraud mapping interface may provide an information source for users to quickly identify compromised locations (e.g., the user may receive the interactive fraud mapping interface or may access the interactive fraud mapping interface via an enterprise organization mobile application, web-based application, or the like). Additionally or alternatively, one or more reports of compromised locations may be generated and transmitted to registered users. In some examples, a user may customize frequency of reports. In some examples, users may select to only receive reports of compromised locations within a predetermined distance of the users selected center point location (e.g., home location, work location, or the like). In some examples, reports of newly identified compromised locations may be transmitted to registered users on a regular basis (e.g., weekly, monthly, or the like). In some examples, if a transaction at a compromised location is identified for a user, an alert may be generated and transmitted to the user.

As discussed, a user may identify one or more center point or “home” locations for display on the interactive fraud mapping interface. For instance, the interactive fraud mapping interface may include the one or more center points locations identified by the user, as well as an area extending out from the center point a predetermined distance (e.g., one mile, five miles, or the like). In some examples, the user may customize predetermined distance. For instance, a user may live in a rural area and may want the interactive fraud mapping interface to include a distance five miles from their home, but may work in a downtown area and may want the interactive fraud mapping interface to display an area one mile around the work location. In some examples, a user may also identify locations to which they travel often. Accordingly, in some arrangements, a user may identify one or more “favorites” locations around which the interactive fraud mapping interface may display compromised locations. In some examples, the interactive fraud mapping interface may default to a current location of a user (e.g., as determined from global positioning system data of a user computing device) and a default distance around that location.

In some examples, the system may predict locations the user may visit and notify a user of compromise at a location. For instance, the machine learning model may identify that a user travels to a particular city once per month and visits a particular coffee shop in that city each day. If a compromise is detected at the coffee shop, the system may alert the user and/or recommend an alternative.

While aspects described herein are directed to providing a map view of compromised locations, in some examples, a list view may be provided alternatively to or in addition to the map view.

As discussed above, one or more additional interfaces may be generated to provide additional details about the incidents of fraud or potential fraud at one or more locations. In some examples, the additional interface may include an option to report fraud. If a user selects that option, the user may be prompted with additional options for selection, such as freezing a payment device, requesting a new payment device, or the like. In some examples, a user may freeze a payment device and the system may monitor the payment device for attempted transactions. If no attempted transactions are detected, the user may select to unfreeze the payment device.

In some examples, the fraud reporting option may be used by user at a particular vendor or retail location who notice something suspicious (e.g., a skimmer appears to be attached to a payment terminal, or the like). The user may then report the suspicious situation and it may be routed to a fraud investigative team within the enterprise organization for investigation. In some examples, an option to upload one or more images of the compromised payment terminal may be provided.

While many arrangements are described in the context of users or customers viewing compromised locations, in some examples, vendors or retailers may register with the system to view compromised locations near their locations. Accordingly, if vendors see an increase in fraud near their location, they may be more diligent in monitoring payment terminals, and the like. Further, in some examples, the data may be used to anticipate future locations at which unauthorized actors may attempt to steal user data. In some examples, external data (e.g., from third-party sources) may also be used to anticipate future issues or compromised locations.

In some examples, notifying a vendor of a potential compromise may enable a vendor system to automatically disable a particular payment terminal associated with the compromise. For instance, a registered retailer or vendor may receive a notification of compromise and the notification may include an instruction causing the compromised payment terminal to be disabled. The vendor or retailer may then enable the payment terminal upon remediation of the issue.

The visual aspects described herein with respect to the interactive fraud mapping interface may enable users to assess risk to their data and make informed decisions about where to execute transactions. In some examples, a user may view an additional interface that provides additional details about the incidents at the selected location. For instance, if a skimmer was installed in a particular payment terminal, the user may use a different terminal (e.g., pump gas at a different pump) or may elect to use a form of payment that does not require insertion into a card slot (e.g., mobile payment app, pay in cash, or the like). In some examples, the disabled payment terminal information may be transmitted to the computing platform and included as an additional detail on an additional interface generated with fraud details for a particular location.

Further, while various aspects discussed herein are provided in the context of viewing the map via a mobile or web-based application of the enterprise organization, in some examples, the interactive fraud mapping interface may be provided via an augmented reality device such that interactive icons noting compromised locations may be shown on an augmented reality display of an area. For instance, a user may view a city block through an augmented reality device and interactive icons may identify compromised locations within the city block. In some examples, geo-tags may be used to identify compromised locations.

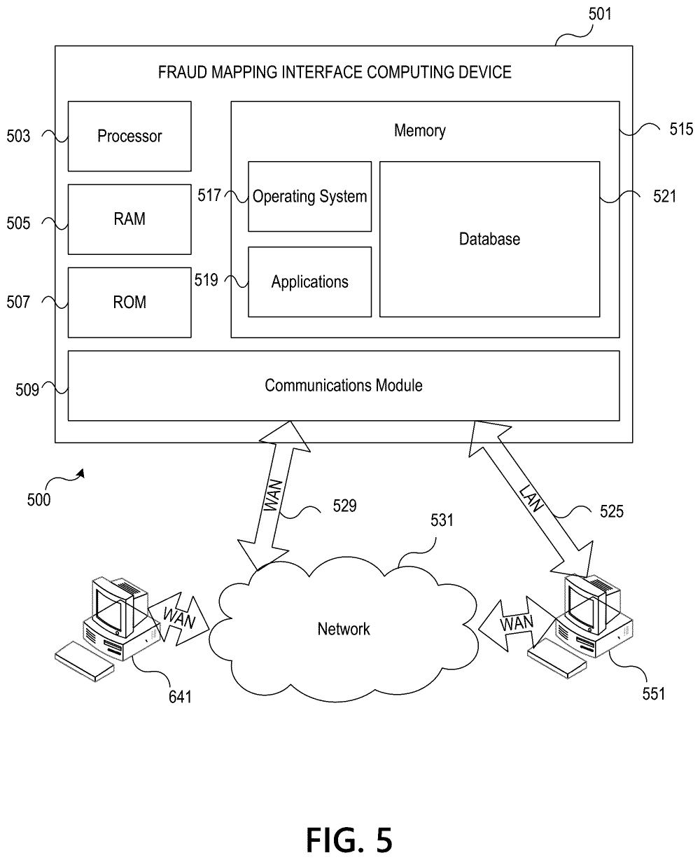

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include fraud mapping interface computing device 501 having processor 503 for controlling overall operation of fraud mapping interface computing device 501 and its associated components, including Random Access Memory (RAM) 505, Read-Only Memory (ROM) 507, communications module 509, and memory 515. Fraud mapping interface computing device 501 may include a variety of computer readable media. Computer readable media may be any available media that may be accessed by fraud mapping interface computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by fraud mapping interface computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on fraud mapping interface computing device 501. Such a processor may execute computer-executable instructions stored on a computer-readable medium.

Software may be stored within memory 515 and/or storage to provide instructions to processor 503 for enabling fraud mapping interface computing device 501 to perform various functions as discussed herein. For example, memory 515 may store software used by fraud mapping interface computing device 501, such as operating system 517, application programs 519, and associated database 521. Also, some or all of the computer executable instructions for fraud mapping interface computing device 501 may be embodied in hardware or firmware. Although not shown, RAM 505 may include one or more applications representing the application data stored in RAM 505 while fraud mapping interface computing device 501 is on and corresponding software applications (e.g., software tasks) are running on fraud mapping interface computing device 501.

Communications module 509 may include a microphone, keypad, touch screen, and/or stylus through which a user of fraud mapping interface computing device 501 may provide input, and may also include one or more of a speaker for providing audio output and a video display device for providing textual, audiovisual and/or graphical output. Computing system environment 500 may also include optical scanners (not shown).

Fraud mapping interface computing device 501 may operate in a networked environment supporting connections to one or more other computing devices, such as computing device 541 and 551. Computing devices 541 and 551 may be personal computing devices or servers that include any or all of the elements described above relative to fraud mapping interface computing device 501.

The network connections depicted in FIG. 5 may include Local Area Network (LAN) 525 and Wide Area Network (WAN) 529, as well as other networks. When used in a LAN networking environment, fraud mapping interface computing device 501 may be connected to LAN 525 through a network interface or adapter in communications module 509. When used in a WAN networking environment, fraud mapping interface computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive fraud reporting data, wherein the fraud reporting data includes a plurality of incidents of potentially fraudulent activity reported by a plurality of users;
responsive to receiving at least a threshold amount of fraud reporting data, analyze the fraud reporting data to identify one or more compromised locations, wherein analyzing the fraud reporting data includes executing a machine learning model using, as inputs, the fraud reporting data, to output the one or more compromised locations;
generate, based on the one or more compromised locations, an interactive fraud mapping interface, wherein the interactive fraud mapping interface includes an interactive icon identifying each compromised location of the one or more compromised locations on a map of a geographical location; and
transmit, to a user computing device, the interactive fraud mapping interface, wherein transmitting the interactive fraud mapping interface to the user computing device causes the user computing device to display the interactive fraud mapping interface on a display of the user computing device.

2. The computing platform of claim 1, wherein a size of the interactive icon indicates a number of incidents of potentially fraudulent activity at a corresponding compromised location.

3. The computing platform of claim 1, wherein a color of the interactive icon indicates a recency of incidents of potentially fraudulent activity at a corresponding compromised location.

4. The computing platform of claim 1, wherein the one or more compromised locations include compromised payment terminals located at the one or more compromised locations.

5. The computing platform of claim 1, further including instructions that, when executed, cause the computing platform to:
receive user input interacting with a first interactive icon corresponding to a first compromised location of the one or more compromised locations;
responsive to receiving the user input, generate a fraud details interface including additional details of incidents of potentially fraudulent activity at the first compromised location; and
transmit the fraud details interface to the user computing device wherein transmitting the fraud details interface to the user computing device causes the user computing device to display the fraud details interface on the display of the user computing device.

6. The computing platform of claim 5, wherein the fraud details interface further includes a selectable option to report a potentially fraudulent incident.

7. The computing platform of claim 5, wherein displaying the fraud details interface includes displaying the fraud details interface overlaying the interactive fraud mapping interface.

8. The computing platform of claim 1, wherein the interactive fraud mapping interface includes a selectable option to modify data layers displayed by the interactive fraud mapping interface.

9. The computing platform of claim 1, further including instructions that, when executed, cause the computing platform to:
generate a notification including at least one compromised location of the one or more compromised locations; and
transmit, to an external entity computing device associated with the compromised location, the notification, wherein transmitting the notification causes the external entity computing device to display the notification on a display of the external entity computing device.

10. The computing platform of claim 9, further including instructions that, when executed, cause the computing platform to:
receive, from the external entity computing device, an indication of remediation of the at least one compromised location; and
responsive to receiving the indication of remediation, modify the interactive fraud mapping interface to include reported remediation at the at least one compromised location of the one or more compromised locations.

11. A method, comprising:
receiving, by a computing platform, the computing platform having at least one processor and memory, fraud reporting data, wherein the fraud reporting data includes a plurality of incidents of potentially fraudulent activity reported by a plurality of users;
responsive to receiving at least a threshold amount of fraud reporting data, analyze, by the at least one processor, the fraud reporting data to identify one or more compromised locations, wherein analyzing the fraud reporting data includes executing a machine learning model using, as inputs, the fraud reporting data, to output the one or more compromised locations;
generating, by the at least one processor and based on the one or more compromised locations, an interactive fraud mapping interface, wherein the interactive fraud mapping interface includes an interactive icon identifying each compromised location of the one or more compromised locations on a map of a geographical location; and
transmitting, by the at least one processor and to a user computing device, the interactive fraud mapping interface, wherein transmitting the interactive fraud mapping interface to the user computing device causes the user computing device to display the interactive fraud mapping interface on a display of the user computing device.

12. The method of claim 11, wherein a size of the interactive icon indicates a number of incidents of potentially fraudulent activity at a corresponding compromised location.

13. The method of claim 11, wherein a color of the interactive icon indicates a recency of incidents of potentially fraudulent activity at a corresponding compromised location.

14. The method of claim 11, wherein the one or more compromised locations include compromised payment terminals located at the one or more compromised locations.

15. The method of claim 11, further including:
receiving, by the at least one processor, user input interacting with a first interactive icon corresponding to a first compromised location of the one or more compromised locations;
responsive to receiving the user input, generating, by the at least one processor, a fraud details interface including additional details of incidents of potentially fraudulent activity at the first compromised location; and
transmitting, by the at least one processor, the fraud details interface to the user computing device wherein transmitting the fraud details interface to the user computing device causes the user computing device to display the fraud details interface on the display of the user computing device.

16. The method of claim 15, wherein the fraud details interface further includes a selectable option to report a potentially fraudulent incident.

17. The method of claim 15, wherein displaying the fraud details interface includes displaying the fraud details interface overlaying the interactive fraud mapping interface.

18. The method of claim 11, wherein the interactive fraud mapping interface includes a selectable option to modify data layers displayed by the interactive fraud mapping interface.

19. One or more non-transitory computer-readable media storing instructions that, when executed by a computing platform comprising at least one processor, memory, and a communication interface, cause the computing platform to:
receive fraud reporting data, wherein the fraud reporting data includes a plurality of incidents of potentially fraudulent activity reported by a plurality of users;
responsive to receiving at least a threshold amount of fraud reporting data, analyze the fraud reporting data to identify one or more compromised locations, wherein analyzing the fraud reporting data includes executing a machine learning model using, as inputs, the fraud reporting data, to output the one or more compromised locations;
generate, based on the one or more compromised locations, an interactive fraud mapping interface, wherein the interactive fraud mapping interface includes an interactive icon identifying each compromised location of the one or more compromised locations on a map of a geographical location; and
transmit, to a user computing device, the interactive fraud mapping interface, wherein transmitting the interactive fraud mapping interface to the user computing device causes the user computing device to display the interactive fraud mapping interface on a display of the user computing device.

20. The one or more non-transitory computer-readable media of claim 19, wherein a size of the interactive icon indicates a number of incidents of potentially fraudulent activity at a corresponding compromised location.

21. The one or more non-transitory computer-readable media of claim 19, wherein a color of the interactive icon indicates a recency of incidents of potentially fraudulent activity at a corresponding compromised location.
